(19) United States
(12) Patent Application Publication
(10) Pub. No.: US 2017/0189923 A1
(43) Pub. Date: Jul. 6, 2017

(54) MANUAL SQUEEZE BOTTLE APPLICATOR FOR ATOMIZING LIQUIDS

(71) Applicants: Broadus TIMMS, Hodges, SC (US); Paul SPENCE, Moore, SC (US)

(72) Inventors: Broadus TIMMS, Hodges, SC (US); Paul SPENCE, Moore, SC (US)

(73) Assignee: Paul SPENCE, Moore, SC (US)

(21) Appl. No.: 15/321,351

(22) PCT Filed: Jun. 23, 2015
(86) PCT No.: PCT/US2015/037159

§ 371 Date: Dec. 22, 2016

Related U.S. Application Data
(60) Provisional application No. 62/015,860, filed on Jun. 23, 2014.

(51) Int. Cl. B05B 11/04; B05B 11/00

(52) U.S. Cl. CPC B05B 11/046; B05B 11/0043; B05B 11/0054; B05B 11/001; B05B 11/047

(57) ABSTRACT

A squeeze bottle, useful for atomizing liquids such as perfumes, medications, insecticides, or the like, by manually squeezing the bottle while orienting the bottle to direct the resulting atomized spray for a desired application. The squeeze bottle utilizes ambient air and contains an inner, compliant pouch for storing a liquid. The pouch is configured so that it deforms by the hydrostatic air pressure generated within the bottle during a squeezing action. This deformation assists in transferring liquid from the pouch into the bottle's spray nozzle where the liquid is atomized in a swirl airflow and dispersed by the expelled ambient air.

### BACKGROUND OF INVENTION

The invention presented has several novel features making it attractive and useful as a consumer device for atomizing a variety of liquids. Many current spray applicators for dispensing products such as perfume or cosmetics rely on a pump type dispenser to produce a spray. These devices utilizing a single linger for operation and typically require the device to be oriented in an upright position. The present invention allows the user to dispense a product as an atomized stream using a natural, gripping and squeezing hand action. In addition, when fitted with a collapsible pouch, the present invention can be operated in multiple orientations. The internal, liquid containing pouch is designed for ease of removal so that the bottle can be reconfigured for a replacement pouch having the same or different liquid contents. Alternatively, the dispensing technique disclosed can be configured for a bottle to have more than one fluid pouch and each pouch selected independently. The compact, integrated design of the bottle. allows for an atomizing dispenser convenient for portable and travel applications compared to traditional siphon type atomizers having a glass bottle and separate squeeze bulb.

### SUMMARY OF THE INVENTION

The present invention relates to a squeezable spray bottle and cap assembly having a liquid filled pouch contained within the squeezable bottle. The volume of the pouch is a fraction of that of the bottle volume, with the remaining volume of the squeeze bottle filled with ambient air. The bottle's cap has an integrated fluid nozzle that communicates with both the air volume of the bottle and the liquid contents of the pouch. The device is designed such that when the bottle is compressed and deformed such as by manually squeezing the bottle, a portion of the air within the bottle exits through the cap's nozzle along with a portion of the fluid contents of the internal pouch. The cap's nozzle is designed so that air passing through the nozzle produces a swirl type flow pattern that efficiently atomizes a portion of the pouch's liquid contents while exiting the nozzle. The liquid containing flexible pouch being internal to the squeeze bottle is sufficiently compliant so that when the bottle is squeezed and compressed, the hydrostatic air pressure generated within the bottle similarly compresses and deforms the pouch, thereby aiding in the transfer of liquid from the pouch to the cap's nozzle. The slight positive pressure of the liquid allows the liquid to be introduced within pressure zones of the nozzle in a less restrictive manner to produce improved atomization. The squeeze bottle is sufficiently resilient to regain its original form and allow subsequent use, whereas the pouch need not be similarly resilient, but only sufficiently compliant to facilitate transfer of the liquid contents.

### BRIEF DESCRIPTION OF DRAWINGS

FIG. 1 shows an assembled squeeze bottle applicator.

FIG. 2 is an exploded view of the squeeze bottle applicator of FIG. 1 showing many of the assembly's key elements.

FIG. 3b is a front view of the squeeze bottle of FIG. 1. FIG. 3a and FIG. 3c are section views.

FIG. 4 is an enlarged view of Detail L of the section view FIG. 3c.

FIG. 5 is an isometric view showing the back side of the squeeze bottle's nozzle plate.

FIG. 6b is a front view of a 60 ml squeeze bottle cap. FIG. 6a and FIG. 6c are section views for illustrating internal fluid passages for a pre-filming type nozzle.

FIG. 7 is an enlarged view of Detail L of FIG. 6a for illustrating the pre-filming nozzle design.

FIG. 8 is an exploded view of an alternative embodiment utilizing a pinch technique to close the fluid feed.

FIG. 9a is a front view of the assembled squeeze bottle of FIG. 8. FIG. 9b is a mid-plane section view for illustrating the pinch technique for sealing the liquid pouch.

FIG. 10 is an exploded view of a configuration having three fluid pouches and a pivoting cap design.

FIG. 11a is a front view of the assembled bottle of FIG. 10. FIG. 11b is mid-plane section view of FIG. 11a for illustrating the internal fluid passages.

FIG. 12 is an exploded view of a pouch assembly of FIG. 10.

FIG. 13a shows a characteristic nozzle profile for converging-diverging nozzle geometries. FIG. 13b shows a characteristic nozzle profile for converging nozzle geometries. Fluid flow would be from left to right.

### DETAILED DESCRIPTION OF PREFERRED EMBODIMENTS

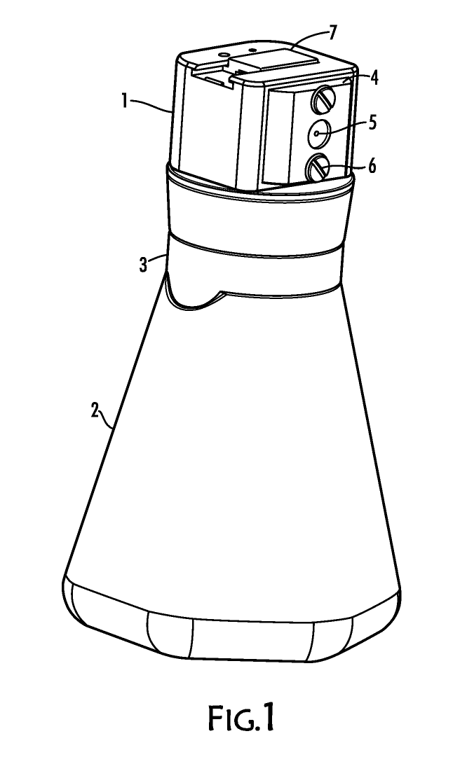

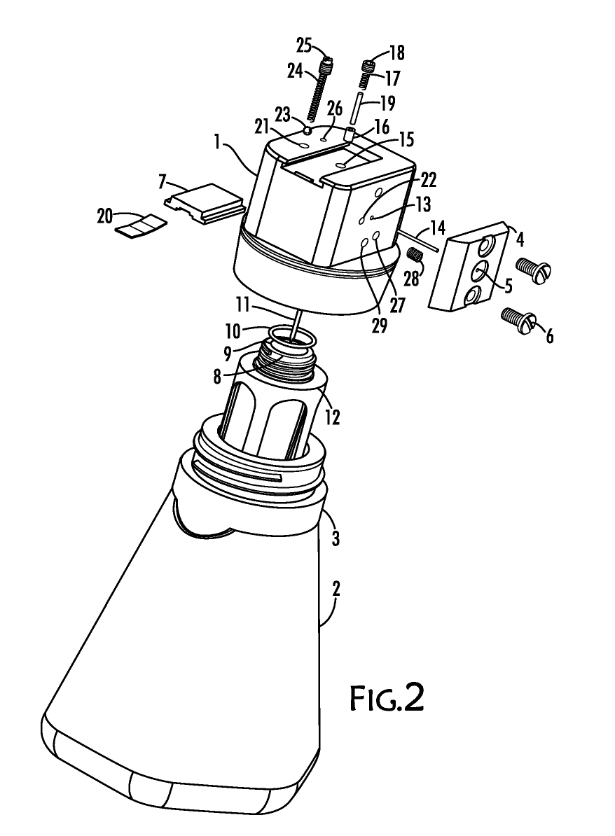

In order to clarify the design and unique features of the present invention a detailed description of preferred embodiments of the invention is facilitated by referring to FIGS. 1-10 with the same element shown in different figures being labeled the same. FIG. 1 illustrates the assembled version of the present invention for a ˜100 mm tall squeeze bottle having a 90 milliliter air volume. FIG. 2 illustrates an exploded view of the same embodiment. Referring to FIG. 1, the assembly consists of a threaded, rigid cap 1 having multiple passages and secured to a compliant yet resilient squeeze bottle 2 via the semi-rigid threaded collar 3. Collar 3 fits over the top lip of squeeze bottle 2 to allow a hermetic seal to be formed between the top lip of bottle 2 and the underside of the cap 1. Cap 1 is fitted with nozzle plate 4 having an orifice 5 through which the atomized spray expels. Nozzle plate 4 is secured to cap 1 via fasteners 6. Slide lock 7 actuates a plunger that seals off the liquid contents of bottle 2 to prevent inadvertent discharge or siphoning.

Referring to FIG. 2, several details of the present invention are further clarified. Housed within bottle 2 is the liquid containing flexible pouch 8 having septum 9. In this embodiment, pouch 8 has a threaded form that allows it to be threaded into the underside of cap 1 and sealed via O-ring 10. Hypodermic needle 11 is secured in cap 1 and positioned to puncture septum 9 and allow the fluid contents of pouch 8 to communicate with internal passages of cap 1. Rigid cage 12 protects punch 8 from excess deformation of bottle 2 without shielding pouch 8 from the hydrostatic air pressure created when bottle 2 is squeezed. Cap 1 can be made of a rigid polymer such as delrin or a high density polyethylene while compliant bottle 2 can be made of a number of flexible yet resilient polymers such as a low density polyethylene, silicone rubber, or even a polyethylene terephthalate (PET). Pouch 8 is made of a compliant material sufficient to allow it to compress during the squeezing process. For a moderate to firm squeeze with human gripping, static air pressure within bottle 2 of nominally 10,000 Pa to 25,000 Pa above normal atmospheric pressure (101,325 Pa) can easily be obtained. A thin polymer wall having a thickness of a few mills (1 mill=0.001 inch) for pouch 8, will typically deform sufficiently for fluid transfer. Depending on the geometry of bottle 2 and contents of pouch 8, the mechanical and barrier properties of pouch 8 can be customized for a variety of applications.

Referring still to FIG. 2, passage 13 in cap 1 communicates with needle 11 and is fitted with stainless steel tube 14. Tube 14 protrudes slightly from the face of cap 1 and into nozzle plate 4, and is aligned coaxially with orifice 5. Tube 14 is typically hypodermic tubing ranging in diameter from 24 to 19 gauge for a 90 ml bottle 2. Liquid passage 15 intersects with passage 13 and needle 11 and is shaped so that the bottom of passage 15 accepts plug 16 and can seal off the liquid flow from needle 11 to passage 13. Spring 17 and set screw 18 are configured to provide slight pressure to plug 16 to prevent siphoning of liquid from pouch 8, but insufficient pressure to prevent opening during the squeezing of bottle 2. Rod 19 fits coaxially into plug 16 and protrudes slightly above the recessed face of cap 1 so that when slide lock 7 is moved inward, leaf spring 20 of slide lock 7 presses against rod 19 to firmly seal plug 16. This prevents inadvertent discharge of liquid from pouch 8.

Referring again to FIG. 2, passage 21 communicates with the interior of bottle 2 and air passage 22 which also communicates with nozzle plate 4. Passage 21 is shaped so that ball 23, spring 24, and set screw 25 form a check valve for air, to allow air expelled during the squeezing of bottle 2 to flow to nozzle plate 4. Passage 26 also communicates with the interior volume of bottle 2 and is similarly fitted with a check valve, but with the valve configured to block air from escaping during squeezing yet allow ambient air entry as bottle 2 recovers after squeezing. The cracking pressure of the check valve formed in passage 21 is set sufficient to force plug 16 to open, whereas the cracking pressure of the check valve of passage 26 is sufficiently small to allow easy entry of air into bottle 2 during recovery after squeezing. For the 90 milliliter silicone bottle of FIG. 1, a suction pressure of 6,200 Pa to 7,500 Pa can be generated by recovery of the compressed bottle 2. Hole 27 is a cross passage connecting to passage 26 with opening closed by plug 28. Hole 29 is a threaded hole for fastener 6.

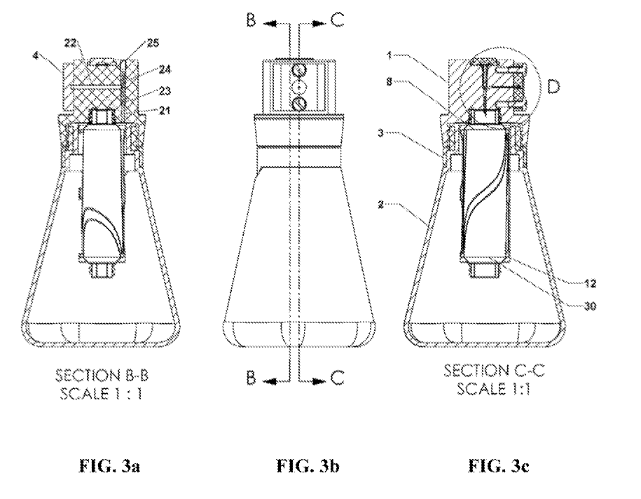

FIG. 3b is a front view of the assembled bottle of FIG. 1. FIG. 3a and FIG. 3c are section views for illustrating fluid passages within cap 1 along section lines B-B and C-C, respectively. The cross section views FIG. 3a and FIG. 3c show a second pouch 30 nested within protective cage 12. The second pouch allows a different fluid to be dispensed by simply inverting the cage and pouch assembly. To provide adequate working air volume of bottle 2, the volume of the pouch and cage assembly is typically kept to ¼ of or less that of bottle 2. Section B-B of FIG. 3 details fluid passages 21 and 22 that communicate air flow from squeeze bottle 2 to nozzle plate 4. Ball 23, spring 24 and set screw 25 can be seen forming a check valve assembly in passage 21. As bottle 2 is squeezed, air pressure within bottle 2 increases to the point where ball 23 moves, allowing air to escape and travel via passage 22 to nozzle plate 4.

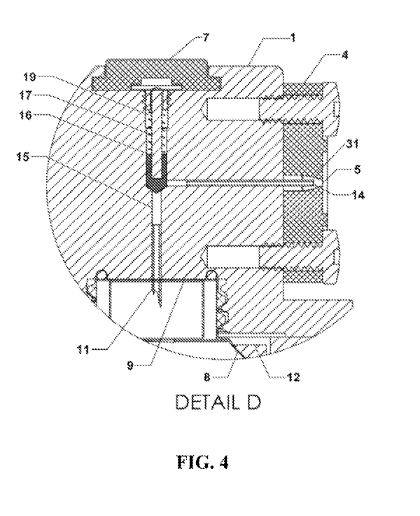

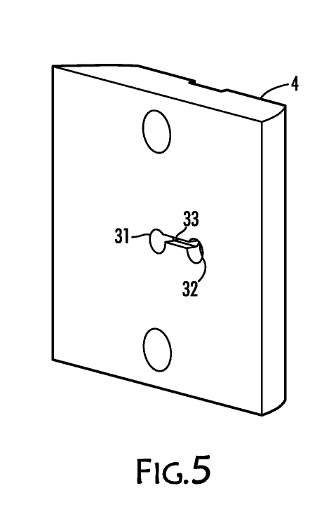

FIG. 4 illustrates an enlarged view of Detail D of FIG. 3c and details the passage network connecting the liquid of pouch 8 to nozzle plate 4 and the location of plug 16 in passage 15. The clearance between plug 16 and passage 15 is sufficient to allow a slip fit between plug 16 and the wall of passage 15, yet small to minimize fluid leakage around plug 16 when plug 16 moves to allow fluid transfer to tube 14. Tube 14 is shown extending into the nozzle cavity 31 having a converging geometry in nozzle plate 4.

FIG. 5 shows an isometric view of the back side of nozzle plate 4. Recess 32 aligns with passage 22 (FIG. 3a, Section B-B) and couples to nozzle cavity 31 via passage 33 to introduce airflow tangentially into nozzle cavity 31. The width, depth and offset of passage 33 along with the shape of nozzle cavity 31 have significant influence on the amount of swirl generated within nozzle cavity 31 and correspondingly the characteristics of the spray pattern. These dimensions were determined in part through computational fluid dynamics or CFD of the nozzle geometry for a desired flow regime as well as through experimental tests.

### Additional Preferred Embodiments

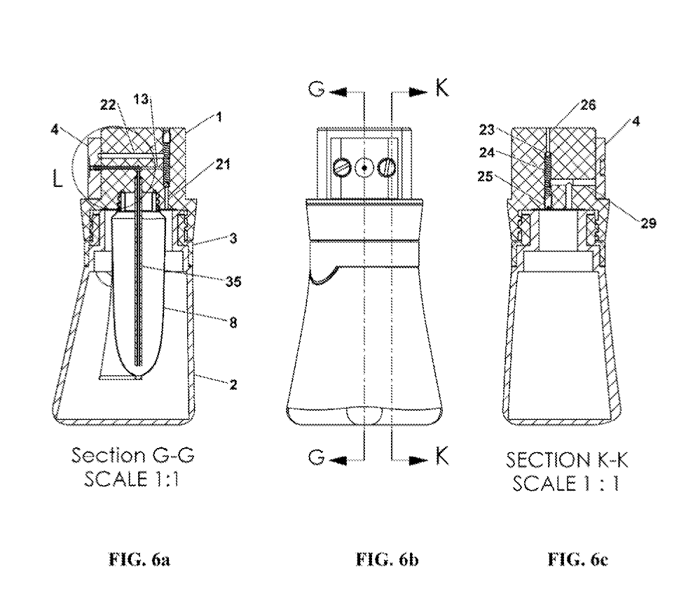

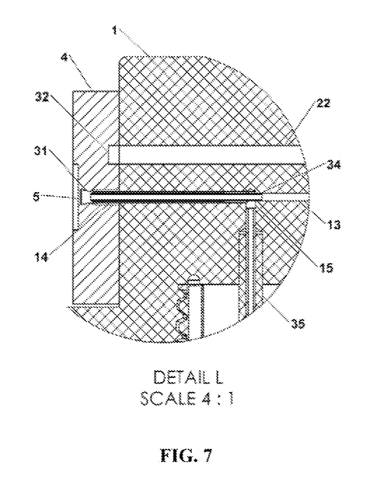

An additional preferred embodiment of the present invention is the use of a “pre-filming” type of nozzle design. FIG. 6b shows the front view of a smaller 60 ml squeeze bottle assembly similar to that of the bottle of FIG. 3b except without a valve mechanism and supply air passages 21 and 22 moved to the mid-plane of cap 1. FIG. 6a and FIG. 6c are section views for illustrating the internal fluid passages of the configuration along section lines G-G and K-K. respectively. Locating fluid passages 21 and 22 on the mid-plane allows passage 13 to be extended to passage 21 to provide airflow into nozzle cavity 31. Referring now to FIG. 7, an enlarged view of Detail L of FIG. 6a, a second feed tube 34 is fitted into the extension of passage 13 and located coaxially with feed tube 14. Feed tube 14 is positioned short of liquid passage 15 and pick-up tube 35 so that the annular region between the inner diameter of tube 14 and outer diameter of tube 34 communicates liquid into nozzle cavity 31. Both tube 14 and tube 35 extend into the throat of nozzle cavity 31 having a converging—diverging geometry in this embodiment. The left end of tube 34 extends slightly past the exit of tube 14 to allow transferred liquid to wick along its outer surface. The combination of strong swirl airflow within nozzle cavity 31 and axially directed airflow escaping tube 34, creates a region of strong shear between the liquid and air to atomize the liquid. This method of creating a thin film of fluid on a surface followed by exposing the fluid to two streams of airflow along a trailing edge is sometimes referred to as a “pre-filming” nozzle design and is frequently used on large fuel nozzles having high flow rates on the order ˜kg/sec.

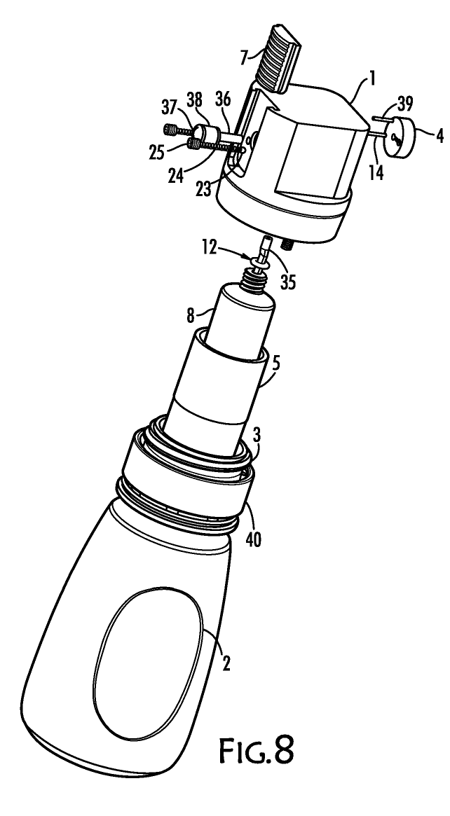

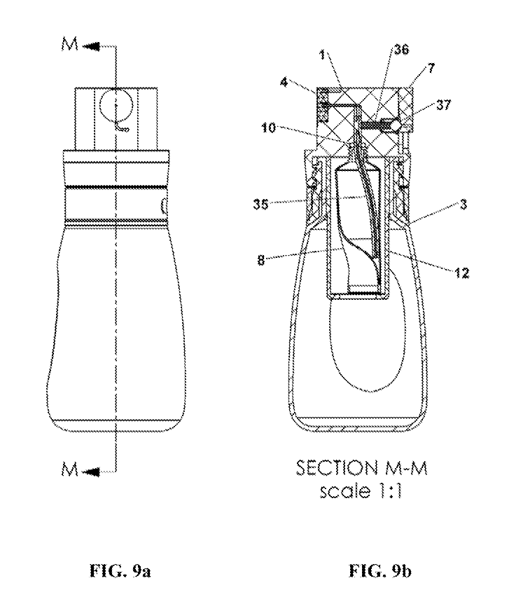

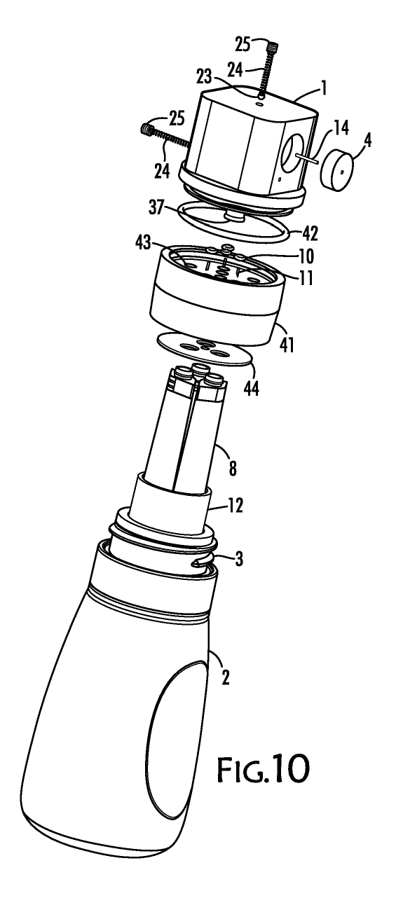

FIG. 8 is are exploded view of a bottle configuration utilizing a pinch technique for sealing pouch 8 liquid contents when the squeeze bottle in not in use. FIG. 9a is a front view of the assembled bottle of FIG. 8. FIG. 9b is a mid-plane section view along section M-M of FIG. 9a for detailing the pinch technique valve. Cap 1 is configured so that flexible transfer tube 35 extends into cap 1 and can be pinched closed by the inward movement of dowel 36. Plunger ball 37 is forced inward by a downward motion of slide 7 which in turn forces dowel 36 inward. Plunger body 38 guides ball 37 and is spring loaded. For this configuration, transfer tube 35 should be made of a resilient polymer having a minimum of set so that it reopens when dowel 36 retracts. O ring 10 seals both pouch 8 and the outside of tube 35 to cap 1. Nozzle plate 4 has a disc shape in this configuration and fits into a counter bore in the face of cap 1 with pin 39 serving to properly align nozzle plate 4. Collar 3 in this configuration is fitted with slip ring 40 for product identification.

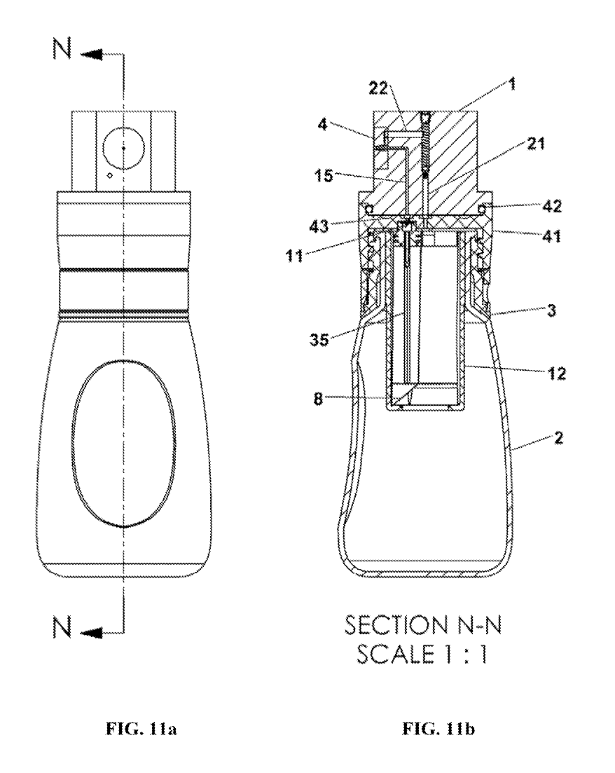

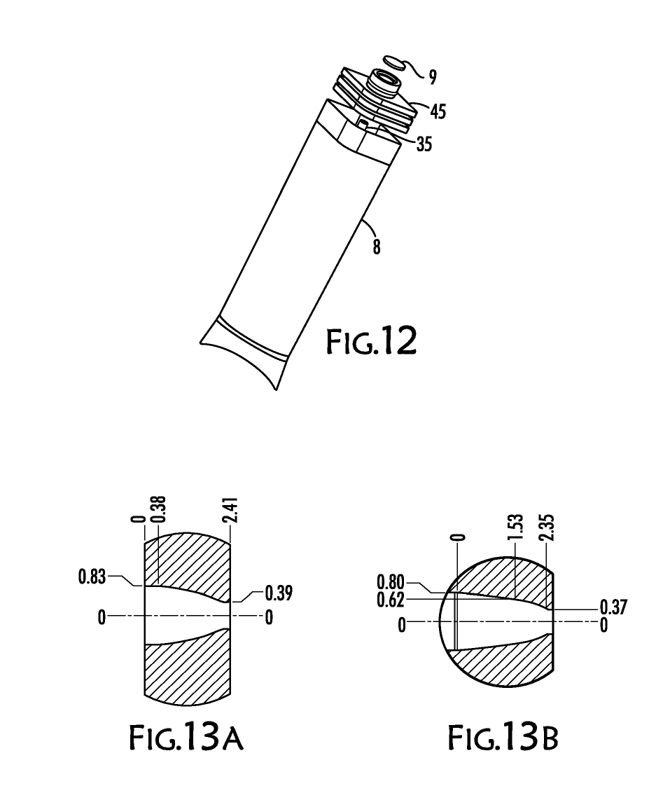

FIG. 10 presents an alternative embodiment of the present invention having a swivel cap 1 to allow three separate pouches 8 to be accessed independently. FIG. 11a is a front view of the assembled bottle of FIG. 10. FIG. 11b is mid-plane section view along section N-N of FIG. 11a to clarify the positioning of fluid passages 21 and 15. Cap base 41 is designed with a recess to accept cap 1 with O ring 42 acting as a retainer. The coaxial geometry allows cap 1 to rotate about its vertical axis and selectively couple fluid passage 15 individually to one of the three fluid pouches 8. O rings 10 seal the fluid passages of cap base 41 to the base of cap 1 while plunger ball 37 seats in an array of detents 43 in the face of cap base 41 for alignment at specific angular positions. This allows the fluid passage of cap 1 to correctly align with a specific hypodermic needle 11 communicating with a specific pouch 8 for liquid transfer, or be misaligned and thereby seal all three pouches 8. Baffle 44 positions pouches 8 for alignment with cap base 41 and the hypodermic needles 11. FIG. 12 is an exploded view of an individual pouch assembly of FIG. 10. Fitment 45 is designed to heat seal to flexible film pouch 8 and mate with baffle 44 of FIG. 10. Fitment 45 is also shaped to accommodate an array of pouches and is configured with a septum 9.

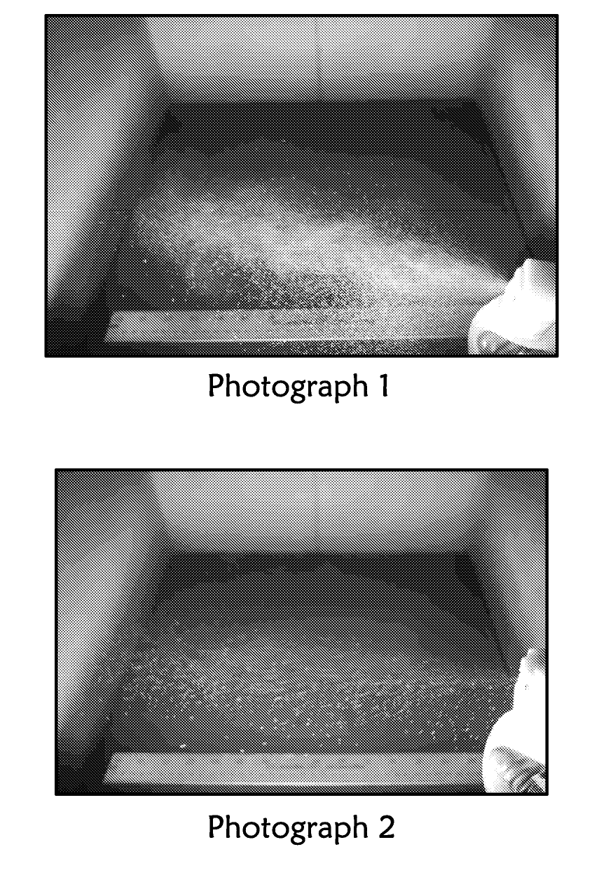

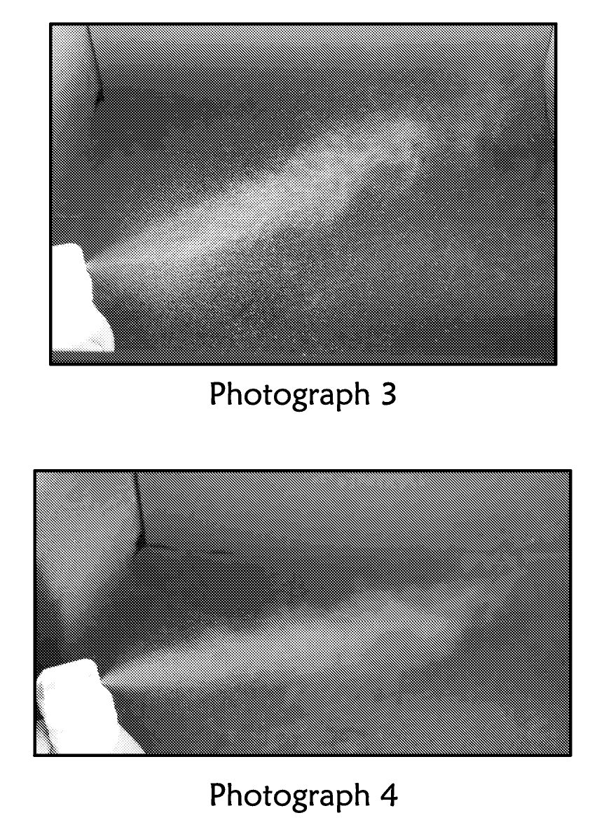

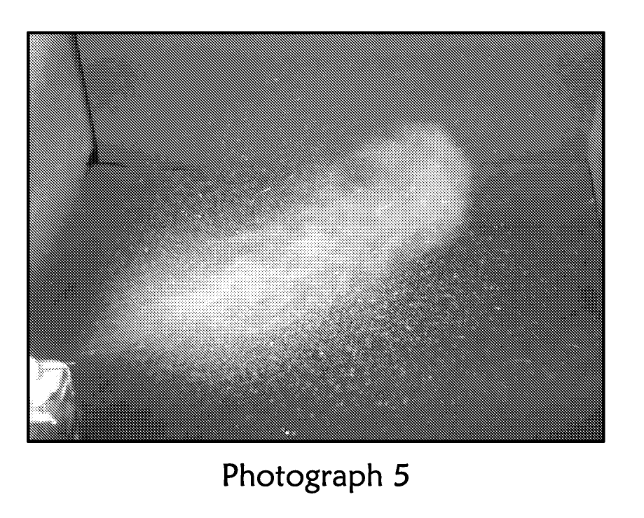

FIG. 13a and FIG. 13b illustrate two characteristic profiles 11 for nozzle cavity 31, a converging-diverging profile and a converging profile (see for example FIG. 7 and FIG. 4). Air flow would be from left to right with a nozzle cavity 31 being a volume of rotation generated by rotating the profile about the horizontal center line. Both nozzle profiles have been shown to work effectively with the present invention. Although the converging-diverging profile allows for a broader range of flow control, the converging-only profile is more desirable from a fabrication perspective. For mass production using injection molding techniques, the converging-only design allows for a simpler mold design.

### CFD Studies

Computational fluid dynamics or CFD was used to predict flow patterns for various nozzle designs. Chart 1 below is a section view of the converging-diverging nozzle design of FIG. 7 and the streamlines derived by a CFD analysis. The size and positions of the coaxial feed tubes configured to form the pre-filming nozzle design were varied in a design study in order to produce a desired flow pattern. The air flow rates determined by the CFD analysis were based on pressure boundary conditions and the geometry of the device rather than prescribed flow rates. The pressure conditions used were in line with basic measurements taken on manually squeezed sample bottles. Chart 1 also depicts the strong swirl generated within the nozzle cavity with the small arrowheads on streamlines indicating flow direction. The more directed airflow due to the air exiting the center coaxial tube can also be seen in the central region of the flow field.

Chart 2 is a cross section view of the nozzle geometry of Chart 1, illustrating the air pressure gradients within the nozzle cavity calculated using CFD. Due to increased air velocity in the converging section of the nozzle cavity 31, a region of sub-atmospheric pressure is generated. In this configuration, this low pressure region connects with both the outlet of the center coaxial feed tube 14 and the annular gap formed by the inner tube 34 and outer tube 14 (see FIG. 7). Due to the hydrostatic pressure acting on inner pouch 8, annular gap does not necessarily need to be in a region of sub-atmospheric pressure to facilitate transfer of the liquid contents of inner pouch 8.

Chart 3 illustrates the airflow streamlines predicted by a CFD simulation of the nozzle geometry of FIG. 3. The spray pattern also includes the trajectories predicted for small, 30 micron droplets as depicted by the small spheres in the image. The pattern appears as a fan shape because the image captures only a segment of the flow field which is rotating about the nozzle axis. By looking at droplet patterns for particle sizes ranging from 10 to 100 microns, an approximation of how the nozzle will behave can be developed. The CFD analysis did not predict the formation of droplets, only the trajectories of particles due to the flow field.

Test bottles based on the above teachings were fabricated and tested. Of particular interest were the spray patterns and ease of use or the device. Photograph 1 illustrates the spray pattern for a squeeze bottle based on the design of FIG. 2 having a single liquid feed tube 14 and converging nozzle profile. The spray pattern was visually enhanced by adding a small amount of fluorescing dye to a 70% isopropyl alcohol/30% water solution and illuminating the spray pattern with a UVB light source. Photos were taken at f5 and 1/250 second shutter speed with a #15 deep yellow filter to enhance the fluorescence. A scale was placed in the foreground for size reference, inside the 46×46×46 cm enclosure. By referencing the shutter speed and scale, the higher velocity fluorescing droplets emerging from the nozzle were estimated to be on order of 1.5 to 3 m/sec, which was in line with those predicted by the CFD analysis. For the 3 oz squeeze bottle used, short burst volume flow rates on the order of 3-5 liters/minute were generated with fluid transfer estimated on the order of 20-40 microliters/second.

Photograph 2 illustrates the flow pattern of the present invention squeeze bottle configured with a pre-filming nozzle design. Due to the directed air flow emerging through inner feed tube 34 (see FIG. 7), the spray pattern is narrower and more focused. The fine annular gap between coaxial tubes restricts the volume of liquid sprayed to approximately ¼ that of the single feed tube design of FIG. 7. Additionally, the cracking pressure of the check valve for expelled air was adjusted slightly higher for this configuration to assist liquid transfer into the annular gap of the coaxial feed tubes. Nozzle plate 14 for this example had a converging-diverging nozzle profile similar to that shown in FIG. 12.

Photograph 3 illustrates the spray pattern for the squeeze bottle design of FIG. 8 dispensing pure water. The pattern is illuminated with a 150 W metal halide lamp having a color temperature of 4000° K. Nozzle plate 4 has a converging nozzle geometry with a 0.025″O.D.×0.013″I.D. feed tube 14. The spray pattern has a well-directed fine mist cloud with a radial pattern produced by the larger droplets.

The spray pattern of the present invention was qualitatively compared to a recently introduced commercial pump type atomizer used for dispensing perfume. A portion of the women's perfume from a commercially available product was transferred into the fluid pouch of a squeeze bottle having the design of FIG. 8 and a converging nozzle plate 4. Photograph 4 shows the spray pattern observed. The cracking pressure of the check valve for the nozzle air supply was minimized to reduce the hydrostatic pressure generated with the squeezing action and slow the introduction of fluid into the nozzle. Introducing the fluid into the nozzle slightly later during the squeezing process allows the fluid to be introduced into a higher velocity air stream for correspondingly greater shear and finer droplet production. This in conjunction with the lower viscosity and higher volatility of the perfume aid to produce a finer spray mist than that observed with water in Photograph 3.

Photograph 5 shows the spray pattern generated by a commercial pump style dispenser. The perfume atomized was the same for both tests depicted in photograph 4 and paragraph 5. The volume of liquid dispensed in photograph 4 was estimated to be ¼ to ⅕ that of the commercial pump of Photograph 5 which dispenses 100-140 microliters per action. The pump dispenser produces a large, fine mist cloud as well as a radial pattern of larger droplets.

The present invention being described above by various embodiments and examples is now defined and limited by the following claims.

1. A bottle assembly comprising:
a compliant squeeze bottle;
a flexible pouch fitting within said squeeze bottle; and
a cap that secures to openings in both said squeeze bottle and said pouch and having passages communicating, with said openings and configured to use ambient air expelled from said squeeze bottle to atomize a portion of liquid contents contained within said pouch.

2. The assembly of claim 1 wherein said cap has a nozzle cavity opening to the ambient environment and said nozzle cavity communicating via passages with the openings of the squeeze bottle and pouch of claim 1 so that air expelled from said squeeze bottle enters said nozzle cavity tangentially to produce a swirl airflow within said nozzle cavity.

3. The assembly of claim 2 wherein said cap has means for introducing liquid from said pouch into said nozzle cavity to facilitate atomizing said liquid by a swirl airflow generated within said nozzle cavity.

4. The assembly of claim 1 wherein said compliant squeeze bottle is made of a compliant plastic material that can be manually deformed but sufficiently resilient to regain its original shape after manual squeezing.

5. The assembly of claim 1 having more than one liquid-containing pouch and having a cap capable of independently accessing each pouch.
